(19) United States
(12) Patent Application Publication
(10) Pub. No.: US 2014/0057070 A1
(43) Pub. Date: Feb. 27, 2014

(54) SHIELD FOR CUPCAKE BAKING TRAY

(71) Applicant: Joann Beltran-Garcia, Exeter, CA (US)

(72) Inventor: Joann Beltran-Garcia, Exeter, CA (US)

(21) Appl. No.: 13/791,898

(22) Filed: May 20, 2013

Related U.S. Application Data
(60) Provisional application No. 61/611,127, filed on Mar. 15, 2012.

(51) Int. Cl. A21B 3/13

(52) U.S. Cl. CPC A21B 3/135; A21B 3/138
USPC 428/131

(57) ABSTRACT

This is directed to systems, processes, machines, and other means that protect cupcake or muffin pans. The invention can alleviate the difficulties caused by spilling batter on the muffin or cupcake pan by providing a shield that can easily be removed prior to baking.

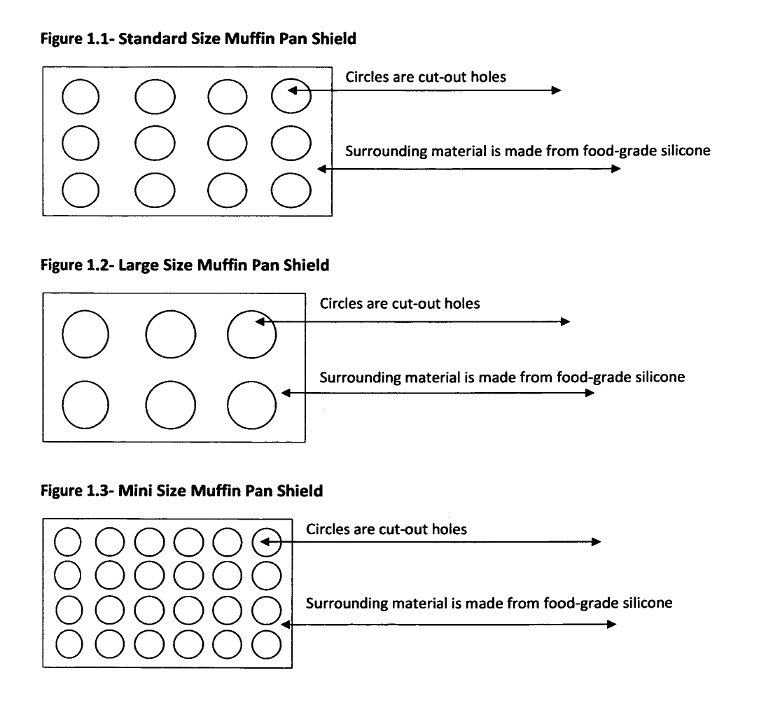

### FIELD OF THE INVENTION

This invention relates to kitchen equipment.

### BRIEF SUMMARY OF THE INVENTION

Methods, systems, and other means are provided for a device that makes baking more efficient. In accordance with some embodiments a shield for protecting a cupcake or muffin pan comprises a sheet of Food and Drug Administration (FDA) Grade silicone and further comprises a series of holes that can fit around cups or liners on the pan.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

The FIGURE shows several views of the device.

### DETAILED DESCRIPTION OF THE INVENTION

The FIGURE shows the device in several embodiments. A manufacturer cuts a sheet of FDA Grade silicone such that the holes in the sheet would be in the same position as a conventional muffin pan or cupcake pan. Further, the sheet would have the same dimensions as a conventional muffin or cupcake pan. The FIGURE shows several different variations where the white area represents the silicon sheet and the black circles represent holes removed from the silicon sheet. After a manufacturer cuts the sheet, the sheet can be dyed to a desirable color.

In other embodiments, the device can be made of disposal type of material, such as wax paper or parchment paper. Additionally, this device can be made in a wide variety of sizes to accommodate the various sizes of cupcake and muffin pans as shown in the figures.

To use the device the user places the sheet over the cupcake or muffin pan and then pours the batter into the cups (or liners if desired). If unwanted batter is spilled on the sheet, the sheet can be removed before baking and then washed.

That which is claimed:

1. A shield for a cupcake baking tray comprising, a sheet made of FDA Grade silicone when the sheet further comprises a series of holes that fit around cups or liners on the pan.
